(19) United States
(12) Patent Application Publication
(10) Pub. No.: US 2025/0279230 A1
(43) Pub. Date: Sep. 4, 2025

(54) Ti-CONTAINING NdFeB MAGNET AND PREPARATION METHOD AND APPLICATION THEREOF

(71) Applicants: BEIJING ZHONG KE SAN HUAN HI-TECH CO., LTD., Beijing (CN); TIANJIN SANHUAN LUCKY NEW MATERIAL CO.,LTD., Tianjin (CN)

(72) Inventors: Zhixue LI, Beijing (CN); Huiqin CAO, Beijing (CN); Xue HAN, Beijing (CN)

(21) Appl. No.: 19/017,117

(22) Filed: Jan. 10, 2025

(30) Foreign Application Priority Data
Mar. 1, 2024 (CN) 202410239497.6

(51) Int. Cl. H01F 1/057

(52) U.S. Cl. CPC H01F 1/0577

(57) ABSTRACT

A Ti-containing NdFeB magnet includes main phase grains, thin-layer grain boundary phases, and triangular region grain boundary phases. TiB₂ crystals are contained in the Ti-containing NdFeB magnet. A total number N of TiB₂ crystals in the Ti-containing NdFeB magnet, a number N₁ of TiB₂ crystals distributed in the main phase grains, and a number N₂ of TiB₂ crystals in the triangular region grain boundary phases satisfy 0≤N₁/N≤0.05 and 0≤N₂/N≤0.3.

### CROSS-REFERENCE TO RELATED APPLICATION

This application claims priority to Chinese Application No. 202410239497.6, filed on Mar. 1, 2024, the entire content of which is incorporated herein by reference.

### TECHNICAL FIELD

The present disclosure relates to rare earth permanent magnet and, in particular, to a Ti-containing NdFeB magnet and a preparation method thereof.

### BACKGROUND

Sintered NdFeB magnets are widely used in the fields of motors, information technology, medical devices, etc., due to their excellent magnetic properties. Especially in the field of new energy vehicles, high-energy motors require high magnet performance. However, the existing sintered NdFeB magnets suffer from a reduction in coercivity (HcJ) at high temperatures, making them prone to irreversible thermal demagnetization. To enhance HcJ and improve thermal stability, grain boundary diffusion processes have been frequently utilized in recent years. This involves diffusing heavy rare-earth elements (such as Dy, Tb, etc.) from the surface of the magnet into its interior, allowing these elements to concentrate in the outer shell region of the main phase grains. This approach effectively increases the HcJ of magnets while inhibiting the reduction of remanence (Br).

However, with the rapidly increasing demand in the magnet application market for low-cost, high-performance sintered NdFeB magnets, there is a pressing need to minimize the usage of heavy rare-earth elements while enhancing the coercivity (HcJ) of the magnets. One approach to achieve this is by mixing NdFeB alloy powder with titanium hydride powder or adding titanium during the melting process of NdFeB alloy to produce Ti-containing NdFeB magnets. These magnets can reduce the usage of heavy rare-earth elements to some extent and improve HcJ to a certain degree. Nonetheless, it is relatively challenging to further enhance HcJ based on the current technology.

### SUMMARY

The purpose of this disclosure is to provide a Ti-containing NdFeB magnet, along with its preparation method and applications. The Ti-containing NdFeB magnet prepared by the method disclosed in this disclosure features a uniform distribution of nanoscale needle-like TiB₂ crystals within the thin-layer grain boundary phase, with minimal TiB₂ crystals present within the thin-layer grain boundary phase. This results in a magnet with high coercivity and high squareness.

In order to achieve the above object, a first aspect of the disclosure provides a Ti-containing NdFeB magnet, which contains main phase grains, thin-layer grain boundary phase, and triangular region grain boundary phase; the Ti-containing NdFeB magnet contains TiB₂ crystals.

The distribution of TiB₂ crystals in the Ti-containing satisfies expressions (1) and (2) below,

$$0 \leq {N}_{1} / N \leq 0.05 ; \qquad expression ( 1 )$$

$$0 \leq {N}_{2} / N \underline{<} 0.3 ; \qquad expression ( 2 )$$

wherein, N₁/N represents the ratio of the number of TiB₂ crystals (N₁) distributed within the main phase grains to the total number of TiB₂ crystals (N) distributed in the main phase grains, triangular region grain boundary phases, and thin-layer grain boundary phases in the Ti-containing NdFeB magnet; and N₂/N represents the ratio of the number of TiB₂ crystals (N₂) in the triangular region grain boundary phases to N.

Optionally, 0≤N₂/N≤0.2.

Optionally, the length of the TiB₂ crystal is in a range of 100 nm to 500 nm, and the width of the TiB₂ crystal is in a range of 1 nm to 20 nm.

Optionally, the distribution of TiB₂ crystals within thin-layer grain boundary phases satisfies expression (3) below.

$$0.3 \leq {L}_{T} / L \leq 0.8 ; \qquad expression ( 3 )$$

wherein, L_{T}/L represents the ratio of the total length L_{T} of TiB₂ crystals within thin-layer grain boundary phases to the total length L of thin-layer grain boundary phases.

Optionally, the Ti-containing NdFeB magnet includes R, Ti, M, B, and Fe, wherein the R element includes at least one of Nd, Pr, Dy, Tb, Ho, La, Y, or Ce, and the M element includes at least one of Cr, Co, Ni, Ga, Cu, Al, Zr, Nb, Mo, Sn, Hf, or W.

In the Ti-containing magnet, the mass percentage of R element is in a range of 28.5% to 31.5%, the mass percentage of Ti element is in a range of 0.05% to 0.75%, the mass percentage of M element is in a range of 1.2% to 2.5%, the mass percentage of B element is in a range of 0.9% to 0.97%, and the remainder is Fe.

A second aspect of the disclosure provides a method of preparing the Ti-containing NdFeB magnet, comprising: sequentially performing molding process on R—Ti-M-B—Fe alloy powder to obtain a green compact, sintering the green compact, and then aging the sintered compact to obtain the magnet.

The sintering process includes the first sintering process and the second sintering process; in the first sintering process, the first sintering temperature is in a range of 480° C. to 850° C., and the first sintering time is in a range of 5 h to 12 h; in the second sintering process, the second sintering temperature is in a range of 900° C. to 1100° C., and the second sintering time is in a range of 1 h to 10 h.

Optionally, in the R—Ti-M-B—Fe alloy powder, R includes at least one of Nd, Pr, Dy, Tb, Ho, La, Y, or Ce, and M includes at least one of Cr, Co, Ni, Ga, Cu, Al, Zr, Nb, Mo, Sn, Hf, or W;

In the R—Ti-M-B—Fe alloy powder, the mass percentage of R element is in a range of 28.5% to 31.5 wt %, the mass percentage of Ti element is in a range of 0.05% to 0.75%, the mass percentage of M element is in a range of 1.2% to 2.5%, the mass percentage of B element is in a range of 0.9% to 0.97%, and the remainder is Fe.

Optionally, the method further comprises: preparing R—Ti-M-B—Fe alloy flakes using rapid solidification process, subjecting the R—Ti-M-B—Fe alloy flakes to hydrogen decrepitation and jet milling to obtain the R—Ti-M-B—Fe alloy powder; the average particle size D50 of the R—Ti-M-B—Fe alloy powder is in a range of 2 μm to 5 μm.

Optionally, the method further comprises: mixing the R₁—Fe—B-M₁ primary alloy powder and the R₂—Ti-M₂ secondary alloy powder to obtain the R—Ti-M-B—Fe alloy powder; the mass ratio of the R₁—Fe—B-M₁ primary alloy powder to the R₂—Ti-M₂ secondary alloy powder is 10:1 to 150:1.

The R₁ includes at least one of Nd, Pr, Dy, Tb, Ho, La, Y, or Ce, and the M₁ includes at least one of Cr, Co, Ni, Ga, Cu, Al, Zr, Nb, Mo, Sn, Hf, or W; in the R₁—Fe—B-M₁ primary alloy powder, the mass percentage of R₁ element is in a range of 28% to 31%, the mass percentage of M₁ element is in a range of 0.5% to 3%, the mass percentage of B element is in a range of 0.85% to 0.97%, and the remainder is Fe.

The R₂ includes at least one of Pr or Nd, the M₂ includes at least one of Co, Cu, Al, or Ga; in the R₂—Ti-M₂ secondary alloy powder, the mass percentage of R element is in a range of 50% to 95%, the mass percentage of Ti element is in a range of 5% to 30%, and the mass percentage of M₂ element is lower than 20%.

Optionally, the method further comprises: preparing R₁—Fe—B-M₁ primary alloy flakes using rapid solidification process, subjecting the R₁—Fe—B-M₁ primary alloy flakes to hydrogen decrepitation and jet milling to obtain the R₁—Fe—B-M₁ primary alloy powder; the average particle size D50 of the R₁—Fe—B-M₁ primary alloy powder is in a range of 2 μm to 5 μm.

Preparing R₂—Ti-M₂ secondary alloy flakes using rapid solidification process, subjecting the R₂—Ti-M₂ secondary alloy flakes to hydrogen decrepitation and jet milling to obtain the R₂—Ti-M₂ secondary alloy powder; the average particle size D50 of the R₂—Ti-M₂ secondary alloy powder is in a range of 0.5 μm to 2 μm.

Optionally, the molding process is an orientation molding process, the orientation magnetic induction intensity is in a range of 1.8 T to 2.5 T.

The aging treatment includes first aging process and second aging process; in the first aging process, the first aging temperature is in a range of 850° C. to 950° C., and the first aging time is in a range of 3 h to 5 h; in the second aging process, the second aging temperature is in a range of 450° C. to 600° C., and the second aging time is in a range of 0.5 h to 5 h.

A third aspect of the disclosure provides a Ti-containing NdFeB magnet prepared by the above method.

The present disclosure employs a segmented sintering process utilizing distinct temperature stages for the green of compacts. Initially, the green compact is held at a first sintering temperature ranging from 480° C. to 850° C. for a duration of 5 h to 10 h. This step facilitates the enhanced distribution of Ti elements within the thin-layer grain boundary phases. Subsequently, during the second sintering stage, conducted at temperatures between 900° C. and 1080° C., the Ti element react with B elements, leading to the in-situ formation of finely dispersed, nano-sized needle-like TiB₂ crystals within the thin-layer grain boundary phases of the magnet. In the ensuing aging process, due to the high melting point of TiB₂ crystals, they remain stationary and do not migrate with the liquid phase formed. Consequently, the abundance of TiB₂ crystals within the thin-layer grain boundary phases persists between adjacent main phase grains. These TiB₂ crystals act as “pinning” agents, effectively inhibiting the growth of the main phase grains by impeding grain boundary movement. The method provided by this disclosure significantly reduces the quantity of TiB₂ crystals within the interior of the main phase grains and the grain boundary phases of triangular regions. The concentration of TiB₂ crystals within the thin-layer grain boundary phases enables excellent magnetic isolation between neighboring main phase grains.

With less heavy rare earth usage or even without heavy rare earth usage, the coercivity and squareness of the Ti-containing NdFeB magnet prepared with Ti are improved, possessing excellent magnetic properties

The other features and advantages of the present disclosure will be explained in detail in the following specific embodiments.

### BRIEF DESCRIPTION OF THE DRAWING

FIG. 1 is a SEM photograph of the Ti-containing NdFeB magnet;

FIG. 2 is a TEM photograph of the TiB₂ crystal in the Ti-containing NdFeB magnet;

FIG. 3 is a schematic diagram illustrating the total length L of the thin-layer grain boundary phases in the Ti-containing NdFeB magnet;

FIG. 4 is a schematic diagram illustrating the total length L_{T} of TiB₂ crystals within the thin-layer grain boundary phases in the Ti-containing NdFeB magnet;

FIG. 5 is an electron diffraction pattern of the TiB₂ crystals in the Ti-containing NdFeB magnet.

### DESCRIPTION OF REFERENCE NUMERALS IN THE DRAWINGS

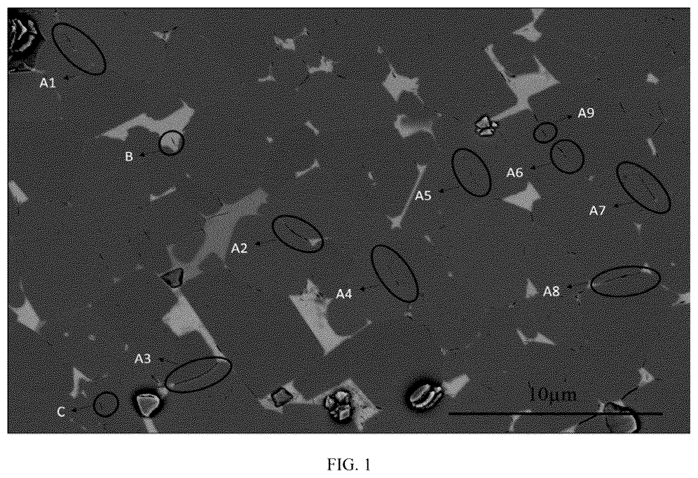

In FIG. 1, A1˜A9 represent TiB₂ crystals in the thin-layer grain boundaries; B represents TiB₂ crystals in the triangular region grain boundary phases; and C represents TiB₂ crystals within the interior of the main phase grains.

Note that A1˜A9 are shown merely for illustrative purposes to demonstrate the presence of TiB₂ crystals in the thin-layer grain boundaries and do not imply that there are only nine TiB₂ crystals present.

### DETAILED DESCRIPTION OF EMBODIMENTS

Specific embodiments of the disclosure are described in detail below. It should be understood that the detailed description and specific embodiments, while indicating the disclosure, are given by way of illustration and explanation only, not limitation.

The first aspect of the present disclosure provides a Ti-containing NdFeB magnet, which comprises main phase grains, thin-layer grain boundary phases, and triangular region grain boundary phases; the Ti-containing NdFeB magnet contains TiB₂ crystals, and the TiB₂ crystals are needle-like granular in morphology.

The distribution of TiB₂ crystals in the Ti-containing NdFeB magnet satisfies the following expressions (1) and (2),

$$0 \leq {N}_{1} / N \leq 0.05 ; \qquad expression ( 1 )$$

$$0 \leq {N}_{2} / N \underline{<} 0.3 ; \qquad expression ( 2 )$$

wherein, N₁/N represents the ratio of the number of TiB₂ crystals (N₁) distributed within the main phase grains to the total number of TiB₂ crystals (N) distributed in the main phase grains, triangular region grain boundary phases, and thin-layer grain boundary phases in the Ti-containing NdFeB magnet; and N₂/N represents the ratio of the number of TiB₂ crystals (N₂) in the triangular region grain boundary phases to N.

In the present disclosure, the distribution of TiB₂ crystals in the Ti-containing NdFeB magnet can be represented by the average distribution of TiB₂ crystals in multiple cross-sections of the magnet, that is, N₁/N values and N₂/N values can be measured separately on multiple different cross-sections of the magnet, and the average values of N₁/N values and N₂/N values on these different cross-sections represent the N₁/N values and N₂/N values inside the magnet, respectively.

For example, the N₁/N and N₂/N values of the Ti-containing NdFeB magnet can be determined by the following method: scanning electron microscopy test on more than 5 cross-sections of the magnet, counting the number of TiB₂ crystals in the main phase grains, triple junctions, and thin layer grain boundaries in the overall or partial areas of each cross-section, calculating the N₁/N and N₂/N values of each cross-section, then calculating the average of N₁/N values and N₂/N values of all cross-sections as the N₁/N and N₂/N values of the Ti-containing NdFeB magnet. In further implementations, when calculating the N₁/N and N₂/N values of each cross-section, randomly select 3 or more observation areas on the cross-section, calculate the N₁/N and N₂/N values of each observation area and take the average as the N₁/N and N₂/N values of the cross-section; for example, the size of the observation area can be 30 μm×20 μm.

In some embodiments, 0≤N₂/N≤0.2.

In a specific embodiment of the disclosure, N₁/N can be 0, 0.01, 0.02, 0.03, 0.04, 0.05, or any value between them. N₂/N can be 0, 0.01, 0.03, 0.05, 0.08, 0.1, 0.12, 0.15, 0.18, 0.2, or any value between them.

The number of TiB₂ crystals distributed inside the main phase grains and the triangular region grain boundary phases in the Ti-containing NdFeB magnet is extremely low. Most of the TiB₂ crystals are uniformly present in the thin-layer grain boundary phases between adjacent main phase grains. The adjacent main phase grains in the magnet are well separated, and the TiB₂ crystals play a “pinning” role in inhibiting the movement of grain boundaries in the main phase grains, effectively preventing grain growth, refining the grains, and thereby improving the residual magnetization and coercivity of the magnet. The Ti-containing NdFeB magnet exhibit high coercivity and high squareness, with excellent magnetic properties.

In the present disclosure, thin-layer grain boundary phases refer to the phases formed between two adjacent main phase grains; triangular region grain boundary phases refer to the grain boundary phases surrounded by three or more main phase grains.

In a specific embodiment of the disclosure, the length of the TiB₂ crystals is in a range of 100 nm to 500 nm, and the width is in a range of 1 nm to 20 nm. Specifically, the length of the TiB₂ crystals can be 100 nm, 120 nm, 150 nm, 180 nm, 200 nm, 220 nm, 250 nm, 270 nm, 300 nm, 320 nm, 350 nm, 380 nm, 400 nm, 410 nm, 420 nm, 450 nm, 480 nm, 500 nm, or any value between them; the width can be 1, 5, 8, 10, 12, 15, 18, 20 nm, or any value between them. In the present disclosure, controlling the length and width of the TiB₂ crystals within the above range is conducive to the uniform distribution of the formed TiB₂ crystals in the thin-layer grain boundary phases, fully exerting the isolating effect of TiB₂ crystals on the main phase grains, producing a “pinning” effect on the movement of grain boundaries in the matrix grains, effectively preventing the growth of matrix grains, further enhancing its magnetic insulation effect, and thus preparing a comprehensive performance magnet with high coercivity and high squareness.

In a specific embodiment of the disclosure, the distribution of TiB₂ crystals within the thin-layer grain boundary phases satisfies expression (3) below,

$$0.3 \leq {L}_{T} / L \leq 0.8 ; \qquad expression ( 3 )$$

wherein, L_{T}/L represents the ratio of the total length L_{T} of TiB₂ crystals within thin-layer grain boundary phases to the total length L of thin-layer grain boundary phases. Specifically, L_{T}/L can be 0.3, 0.35, 0.4, 0.43, 0.5, 0.55, 0.58, 0.6, 0.65, 0.7, 0.75, 0.8, or any value between them. In the above embodiments, a large number of TiB₂ crystals in the thin intergranular phase between adjacent main phase grains can effectively separate the main phase grains of the magnet, exert a “pinning” effect on the movement of grain boundaries of primary phase grains, effectively preventing grain growth, refining the grains, and thereby improving the residual magnetization and coercivity of the magnet. The Ti-containing NdFeB magnet exhibit high coercivity, high squareness and high remanence, with excellent magnetic properties.

In the present disclosure, the ratio of the total length L_{T} of TiB₂ crystals in the thin-layer grain boundary phase of a magnet to the total length L of the thin-layer grain boundary phase can be represented by the average ratio of the length of TiB₂ crystals in the thin-layer grain boundary phase to the length of the thin-layer grain boundary phase in multiple sections inside the magnet, that is, the L_{T}/L value can be determined separately for multiple different sections of the magnet, and the average value of the L_{T}/L values in these multiple different sections represents the L_{T}/L value inside the magnet.

For example, the L_{T}/L value of the Ti-containing NdFeB magnets can be determined by the following method: scanning electron microscope tests on more than 5 arbitrary sections of the magnet, collecting L_{T}/L values for the entire or partial areas of each section, calculating the L_{T}/L value for each section, and then determine the average value as the L_{T}/L value of the Ti-containing NdFeB magnet. In a further implementations, when calculating the L_{T}/L value for each section, more than 3 observation areas can be randomly selected within that section, the L_{T}/L value for each observation area is calculated separately, and the average value is taken as the L_{T}/L value for that section; for example, the size of the observation area can be 30 μm×20 μm.

In a specific embodiment of the disclosure, the average grain size of the main phase grains is lower than 5 μm.

In the present disclosure, the TiB₂ crystals abundantly present in the thin-layer grain boundary phases of the Ti-containing NdFeB magnets can control effectively the grain size of the main phase grains, leading to a significant improvement in the magnet performance.

The Ti-containing NdFEB magnet includes R, Ti, M, B, and Fe, wherein the R element includes at least one of Nd, Pr, Dy, Tb, Ho, La, Y, or Ce, and the M element includes at least one of Cr, Co, Ni, Ga, Cu, Al, Zr, Nb, Mo, Sn, Hf, or W.

In the Ti-containing magnet, the mass percentage of R element is in a range of 28.5% to 31.5%, the mass percentage of Ti element is in a range of 0.05% to 0.75%, the mass percentage of M element is in a range of 1.2% to 2.5%, the mass percentage of B element is in a range of 0.9% to 0.97%, and the remainder is Fe.

A second aspect of the disclosure provides a method of preparing the Ti-containing NdFeB magnet, comprising: sequentially performing molding process on R—Ti-M-B—Fe alloy powder to obtain a green compact, sintering the green compact, and then aging the sintered compact to obtain the magnet.

In the first sintering process, the first sintering temperature is in a range of 480° C. to 850° C., and the first sintering time is in a range of 5 h to 12 h; in the second sintering process, the second sintering temperature is in a range of 900° C. to 1100° C., and the second sintering time is in a range of 1 h to 10 h.

In a specific embodiment of the disclosure, the temperature of the first sintering treatment can be 480° C., 500° C., 550° C., 580° C., 600° C., 620° C., 650° C., 700° C., 720° C., 750° C., 765° C., 800° C., or any value between them, and the first sintering time can be 5 h, 5.5 h, 6 h, 6.5 h, 7 h, 8 h, 9 h, 9.5 h, 10 h, 10.5 h, 11 h, 12 h, or any value between them.

The inventors of the disclosure have further discovered that in the current state of the art, TiB₂ crystals formed in Ti-containing NdFeB magnets are concentrated in the triangular region grain boundary phases, where they exhibit relatively low isolation effects on the main phase grains, thereby limiting further enhancement of the coercivity. Therefore, the present disclosure aims to adjust the process to control the distribution of TiB₂ crystals within the magnet, promoting their presence predominantly in the thin-layer grain boundary phases. This strategic placement effectively isolates the main phase grains and exerts a “pinning” effect on their grain boundary movement, thereby further enhancing the coercivity of the magnet.

The present disclosure employs a segmented sintering process utilizing distinct temperature stages for the green of compacts. Initially, the green compact is held at a first sintering temperature ranging from 480° C. to 850° C. for a duration of 5 h to 10 h. This step facilitates the enhanced distribution of Ti elements within the thin-layer grain boundary phases. Subsequently, during the second sintering stage, conducted at temperatures between 900° C. and 1080° C., the Ti element react with B elements, leading to the in-situ formation of finely dispersed, nano-sized needle-like TiB₂ crystals within the thin-layer grain boundary phases of the magnet. In the ensuing aging process, due to the high melting point of TiB₂ crystals, they remain stationary and do not migrate with the liquid phase formed. Consequently, the abundance of TiB₂ crystals within the thin-layer grain boundary phases persists between adjacent main phase grains. These TiB₂ crystals act as “pinning” agents, effectively inhibiting the growth of the main phase grains by impeding grain boundary movement. The method provided by this disclosure significantly reduces the quantity of TiB₂ crystals within the interior of the main phase grains and the grain boundary phases of triangular regions. The concentration of TiB₂ crystals within the thin-layer grain boundary phases enables excellent magnetic isolation between neighboring main phase grains.

With less heavy rare earth usage or even without heavy rare earth usage, the coercivity and squareness of the Ti-containing NdFeB magnet prepared with Ti are improved, possessing excellent magnetic properties

In some embodiments, forming treatment, sintering treatment, and aging treatment can be carried out using conventional equipment in the field.

In some embodiments, the temperature of the first sintering is in a range of 850° C. to 950° C., and the first sintering time is in a range of 5 h to 12 h; the temperature of the second sintering is in a range of 900° C. to 1080° C., and the second sintering time is in a range of 1 h to 6 h. In the above embodiment, controlling the temperature of each sintering treatment within the disclosed range can allow Ti elements to diffuse more fully and uniformly in the thin-layer grain boundary phases, further reducing the number of TiB₂ crystals in the main phase grains interior and triangular region grain boundary phases, resulting in a large amount of needle-like TiB₂ crystals to exist in the thin-layer grain boundary phases and be distributed evenly, further promoting their magnetic isolation effect in the thin-layer grain boundary phases, so that the prepared magnet has high coercivity and high squareness ratio.

In a specific embodiment of the disclosure, in the R—Ti-M-B—Fe alloy powder, R includes at least one of Nd, Pr, Dy, Tb, Ho, La, Y, or Ce, and M includes at least one of Cr, Co, Ni, Ga, Cu, Al, Zr, Nb, Mo, Sn, Hf, or W;

In a specific embodiment of the disclosure, the mass percentage of R element is in a range of 28.5% to 31.5 wt %, the mass percentage of Ti element is in a range of 0.05% to 0.75%, the mass percentage of M element is in a range of 1.2% to 2.5%, the mass percentage of B element is in a range of 0.9% to 0.97%, and the remainder is Fe.

In a specific embodiment of the disclosure, the mass percentage of Ti can be 0.05%, 0.1%, 0.15%, 0.2%, 0.28%, 0.3%, 0.35%, 0.4%, 0.42%, 0.45%, 0.5%, 0.55%, 0.58%, 0.6%, 0.65%, 0.7%, 0.72%, 0.75%, or a numerical value in between them; the mass percentage of B can be 0.9%, 0.91%, 0.92%, 0.93%, 0.94%, 0.95%, 0.96%, 0.97%, or a numerical value in between them.

In a specific embodiment of the disclosure, a single alloy method is employed, which further comprises: preparing R—Ti-M-B—Fe alloy flakes using rapid solidification process, subjecting the R—Ti-M-B—Fe alloy flakes to hydrogen decrepitation and jet milling to obtain the R—Ti-M-B—Fe alloy powder; the average particle size D50 of the R—Ti-M-B—Fe alloy powder is in a range of 2 μm to 5 μm.

In a specific embodiment of the disclosure, the magnet is prepared using the dual-alloy method to further reduce the number of TiB₂ crystals within the interior of the main phase grains and the grain boundary phases of triangular regions, thereby further improving the TiB₂ crystals in the grain boundary phase of the thin layer, and improving the coercivity and squareness of the prepared magnet. Specifically, the method also includes: mixing R₁—Fe—B-M₁ primary alloy powder with R₂—Ti-M₂ secondary alloy powder to obtain the R—Ti-M-B—Fe alloy powder.

In a specific embodiment of the disclosure, the mass ratio of the R₁—Fe—B-M₁ primary alloy powder to the R₂—Ti-M₂ secondary alloy powder is 10:1 to 150:1, in some embodiments the mass ratio is 20:1 to 135:1. Specifically, the mass ratio of the main alloy raw materials R₁—Fe—B-M₁ to the auxiliary alloy raw materials R₂—Ti-M₂ can be 20:1, 30:1, 50:1, 75:1, 90:1, 100:1, 110:1, 120:1, 130:1, 135:1, or any value between them. In the above embodiment, controlling the mass ratio of the primary alloy powder to the secondary alloy powder avoids excessive addition of rare earth elements, which would reduce the residual magnetism of the magnet.

In a specific embodiment of the disclosure, the R₁ includes at least one of Nd, Pr, Dy, Tb, Ho, La, Y, or Ce, and the M₁ includes at least one of Cr, Co, Ni, Ga, Cu, Al, Zr, Nb, Mo, Sn, Hf, or W; in the R₁—Fe—B-M₁ primary alloy powder, the mass percentage of R₁ element is in a range of 28% to 31%, the mass percentage of M₁ element is in a range of 0.5% to 3%, the mass percentage of B element is in a range of 0.85% to 0.97%, and the remainder is Fe.

In a specific embodiment of the disclosure, the R₂ includes at least one of Pr or Nd, the M₂ includes at least one of Co, Cu, Al, or Ga; in the R₂—Ti-M₂ secondary alloy powder, the mass percentage of R₂ element is in a range of 50% to 95%, the mass percentage of Ti element is in a range of 5% to 30%, and the mass percentage of M₂ element is lower than 20%. Specifically, the mass percentage of Ti can be 5%, 10%, 12%, 15%, 20%, 22%, 25%, 28%, 30%, or a numerical value in between them; the mass percentage of M₂ can be 0, 1%, 2%, 5%, 8%, 10%, 15%, 18%, 20%, or a numerical value in between them.

In a specific embodiment of the disclosure, the method further comprises: preparing R₁—Fe—B-M₁ primary alloy flakes using rapid solidification process, subjecting the R₁—Fe—B-M₁ primary alloy flakes to hydrogen decrepitation and jet milling to obtain the R₁—Fe—B-M₁ primary alloy powder; the average particle size D50 of the R₁—Fe—B-M₁ primary alloy powder is in a range of 2 μm to 5 μm.

Preparing R₂—Ti-M₂ secondary alloy flakes using rapid solidification process, subjecting the R₂—Ti-M₂ secondary alloy flakes to hydrogen decrepitation and jet milling to obtain the R₂—Ti-M₂ secondary alloy powder; the average particle size D50 of the R₂—Ti-M₂ secondary alloy powder is in a range of 2 μm to 5 μm.

In the above embodiment of the disclosure, when the average particle size D50 of the R₁—Fe—B-M₁ primary alloy powder and the R₂—Ti-M₂ secondary alloy powder is in a range of 2 μm to 5 μm, the dispersion uniformity of the mixed powders is optimized, resulting in further improvement of the uniformity of Ti element diffusion during the sintering process.

In a specific embodiment of the disclosure, the molding process is an orientation molding process, the orientation magnetic induction intensity is in a range of 1.8 T to 2.5 T.

In a specific embodiment of the disclosure, the aging treatment includes first aging process and second aging process; in the first aging process, the first aging temperature is in a range of 850° C. to 950° C., and the first aging time is in a range of 3 h to 5 h; in the second aging process, the second aging temperature is in a range of 450° C. to 600° C., and the second aging time is in a range of 0.5 h to 5 h.

In a specific embodiment of the disclosure, the hydrogen decrepitation treatment is conducted at a hydrogen decrepitation pressure ranging from 0.2 MPa to 0.4 MPa, with a hydrogen decrepitation temperature between 550° C. and 600° C.; the jet milling for micro-pulverization is carried out at a grinding pressure of 0.5 MPa to 0.9 MPa.

A third aspect of the disclosure provides a method of preparing the Ti-containing NdFeB magnet by the method described in the present disclosure.

In a specific embodiment of the disclosure, a diffusion source containing heavy rare earth elements (e.g. Dy, Tb) can be used to perform grain boundary diffusion treatment on the Ti-containing NdFeB magnet prepared in the present disclosure.

The Ti-containing NdFeB magnet in the present disclosure possesses high residual magnetism, high coercivity, and high squareness.

The disclosure is further illustrated by the following embodiments, but is not to be construed as being limited thereby. The raw materials used in the embodiments are all available from commercial sources.

### Embodiment 1

Preparing the R₁—Fe—B-M₁ primary alloy powder and the R₂—Ti secondary alloy powder by the following steps:

Preparing the R₁—Fe—B-M₁ primary alloy powder: the raw material for the R₁—Fe—B-M₁ primary alloy is expressionted with a specific mass percentage (wt %) composition, where R₁ represents PrNd and M₁ comprises Ga, Cu, Co, and Al. The precise composition includes 30.5 wt % PrNd, 0.15 wt % Ga, 0.25 wt % Cu, 0.91 wt % Co, 0.25 wt % Al, 0.91 wt % B, and the remainder being Fe. This expressionted raw material is then processed into R₁—Fe—B-M₁ primary alloy rapid solidification flakes utilizing a rapid solidification technique. During this process, the rollers are operated at a surface linear velocity of 0.85 m/s, and the casting temperature is maintained at 1460° C. Subsequently, the R₁—Fe—B-M₁ primary alloy rapid solidification flakes undergo hydrogen crushing and jet milling to produce R₁—Fe—B-M₁ primary alloy powder. The hydrogen crushing step is carried out at a hydrogen absorption pressure of 0.3 MPa, followed by dehydrogenation at 550° C. The jet milling is conducted at a grinding pressure of 0.55 MPa, yielding R₁—Fe—B-M₁ primary alloy powder with an average particle size (D50) of 3.8 μm.

Preparing the R₂—Ti secondary alloy powder: the raw material for the R₂—Ti secondary alloy is expressionted with a specific mass percentage (wt %) composition, where R₂ represents PrNd, PrNd accounts for 85 wt %, and Ti accounts for 15 wt %. This expressionted raw material is then processed into R₂—Ti secondary alloy rapid solidification flakes utilizing a rapid solidification technique. Subsequently, the R₂—Ti secondary alloy rapid solidification flakes undergo hydrogen crushing and jet milling to produce R₂—Ti secondary alloy powder. The hydrogen crushing step is carried out at a hydrogen absorption pressure of 0.3 MPa, followed by dehydrogenation at 550° C. The jet milling is conducted at a grinding pressure of 0.5 MPa, yielding R₂—Ti secondary alloy powder with an average particle size (D50) of 1 μm.

Preparing the Ti-containing NdFeB magnet by using the R₁—Fe—B-M₁ primary alloy powder and the R₂—Ti secondary alloy powder:

Mixing the R₁—Fe—B-M₁ primary alloy powder and the R₂—Ti secondary alloy powder in a weight ratio of 99:1 to obtain R—Ti-M-B—Fe alloy powder. In the R—Ti-M-B—Fe alloy powder, PrNd accounts for 31 wt %, Ga for 0.15 wt %, Cu for 0.25 wt %, Co for 0.9 wt %, Al for 0.25 wt %, B for 0.9 wt %, Ti for 0.15 wt %, and the rest is Fe. Following the molding, sintering, and aging treatments of the obtained R—Ti-M-B—Fe alloy powder, the material is mechanically machined into a Ti-containing NdFeB magnet, designated as CT-1, with dimensions of 15 mm in thickness (orientation direction), 20 mm in length, and 40 mm in width. The molding treatment is oriented molding under N₂ gas protection with an oriented magnetic induction strength of 2 T. The sintering treatment includes the first sintering treatment at 550° C. for 8 h and the second sintering treatment at 1060° C. for 6 h followed by air quenching to room temperature. The aging treatment consists of the first aging treatment at 850° C. for 3.5 h and the second aging treatment at 460° C. for 1 h.

The microstructure of the Ti-containing NdFeB magnet CT-1 was tested. The analysis of the test results showed that CT-1 consists of main phase grains and grain boundary phases, including thin-layer grain boundary phases and triangular region grain boundary phases. Thin-layer grain boundary phases refer to the grain boundary phases formed between two adjacent main phase grains, while triangle region grain boundary phases are the grain boundary phases surrounded by three or more main phase grains.

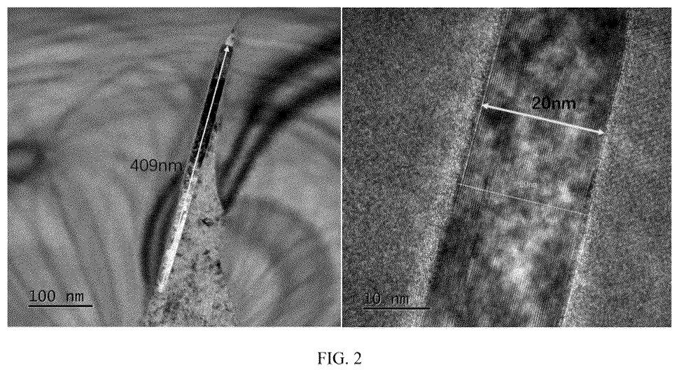

The distribution of TiB₂ crystals in the Ti-containing NdFeB magnets prepared in Example 1 and the distribution of TiB₂ crystals in the thin-layer grain boundary phase were detected. As shown in FIG. 1 and FIG. 2, a large number of needle-like black crystals, namely TiB₂ crystals, were observed in the magnet. The TiB₂ crystals are mainly distributed in the thin-layer grain boundary phase between adjacent main phase grains. The measurements showed that L_{T}/L was 0.45, N₁/N was 0.02, and N₂/N was 0.09, indicating that only a small amount of TiB₂ crystals existed in the interior of the main phase grains and in the triangular region grain boundary phase, while the majority of needle-like TiB₂ crystals were located in the thin-layer grain boundary phase between adjacent primary phase grains, effectively separating the main phase grains, thereby endowing the magnet with excellent comprehensive magnetic properties.

### Embodiment 2

Referring to the preparation method in Embodiment 1, the difference in Embodiment 2 lies in the first sintering, where the temperature of the first sintering treatment is set at 490° C. with a holding time of 8 h, resulting in a Ti-containing NdFeB magnet 2, designated as CT-2.

### Embodiment 3

Preparing the R₁—Fe—B-M₁ primary alloy powder and the R₂—Ti secondary alloy powder by the following steps:

Preparing the R₁—Fe—B-M₁ primary alloy powder: the raw material for the R₁—Fe—B-M₁ primary alloy is expressionted with a specific mass percentage (wt %) composition, where R₁ represents PrNd and M₁ comprises Ga, Co, and Al. The precise composition includes 29.5 wt % PrNd, 0.21 wt % Ga, 0.21 wt % Co, 0.26 wt % Al, 0.96 wt % B, and the remainder being Fe. This expressionted raw material is then processed into R₁—Fe—B-M₁ primary alloy rapid solidification flakes utilizing a rapid solidification technique. During this process, the rollers are operated at a surface linear velocity of 0.85 m/s, and the casting temperature is maintained at 1460° C. Subsequently, the R₁—Fe—B-M₁ primary alloy rapid solidification flakes undergo hydrogen crushing and jet milling to produce R₁—Fe—B-M₁ primary alloy powder. The hydrogen crushing step is carried out at a hydrogen absorption pressure of 0.3 MPa, followed by dehydrogenation at 550° C. The jet milling is conducted at a grinding pressure of 0.55 MPa, yielding R₁—Fe—B-M₁ primary alloy powder with an average particle size (D50) of 3.8 μm.

Preparing the R₂—Ti secondary alloy powder: the raw material for the R₂—Ti-M₂ secondary alloy is expressionted with a specific mass percentage (wt %) composition, where R₂ represents PrNd and M₂ comprises Cu and Ti, wherein, PrNd accounts for 82 wt %, Ti accounts for 10 wt % and Cu accounts for 8 wt %. This expressionted raw material is then processed into R₂—Ti-M₂ secondary alloy rapid solidification flakes utilizing a rapid solidification technique. Subsequently, the R₂—Ti-M₂ secondary alloy rapid solidification flakes undergo hydrogen crushing and jet milling to produce R₂—Ti-M₂ secondary alloy powder. The hydrogen crushing step is carried out at a hydrogen absorption pressure of 0.3 MPa, followed by dehydrogenation at 550° C. The jet milling is conducted at a grinding pressure of 0.5 MPa, yielding R₂—Ti-M₂ secondary alloy powder with an average particle size (D50) of 1 μm.

Preparing the Ti-containing NdFeB magnet by using the R₁—Fe—B-M₁ primary alloy powder and the R₂—Ti secondary alloy powder:

Mixing the R₁—Fe—B-M₁ primary alloy powder and the R₂—Ti-M₂ secondary alloy powder in a weight ratio of 39:1 to obtain R—Ti-M-B—Fe alloy powder. In the R—Ti-M-B—Fe alloy powder, PrNd accounts for 30.8 wt %, Ga for 0.2 wt %, Cu for 0.2 wt %, Co for 1.3 wt %, Al for 0.25 wt %, B for 0.94 wt %, Ti for 0.25 wt %, and the rest is Fe. Following the molding, sintering, and aging treatments of the obtained R—Ti-M-B—Fe alloy powder, the material is mechanically machined into a Ti-containing NdFeB magnet, designated as CT-3, with dimensions of 15 mm in thickness (orientation direction), 20 mm in length, and 40 mm in width. The molding treatment is oriented molding under N₂ gas protection with an oriented magnetic induction strength of 2 T. The sintering treatment includes the first sintering treatment at 650° C. for 7 h and the second sintering treatment at 1060° C. for 5 h followed by air quenching to room temperature. The aging treatment consists of the first aging treatment at 850° C. for 3.5 h and the second aging treatment at 460° C. for 1 h.

### Embodiment 4

Referring to the preparation method in Embodiment 3, the difference in Embodiment 4 lies in the composition of the R₂—Ti-M₂ secondary alloy: the raw material for the R₂—Ti-M₂ secondary alloy is expressionted with a specific mass percentage (wt %) composition, where R₂ represents PrNd and M₂ comprises Cu and Ti, wherein, PrNd accounts for 57 wt %, Ti accounts for 35 wt % and Cu accounts for 8 wt %. The obtained Ti-containing NdFeB magnet 4 is designated as CT-4.

### Embodiment 5

Preparing the R—Ti-M-B—Fe alloy powder by the following steps: the raw material for the R—Ti-M-B-Fer alloy is expressionted with a specific mass percentage (wt %) composition, where R represents PrNd and M comprises Ga, Cu, Co, and Al. The precise composition includes 30.5 wt % PrNd, 0.2 wt % Ga, 0.2 wt % Cu, 0.8 wt % Co, 0.25 wt % Al, 0.1 wt % Ti, 0.9 wt % B, and the remainder being Fe. This expressionted raw material is then processed into R—Ti-M-B—Fe alloy rapid solidification flakes utilizing a rapid solidification technique. During this process, the rollers are operated at a surface linear velocity of 0.85 m/s, and the casting temperature is maintained at 1460° C. Subsequently, the R—Ti-M-B—Fe alloy rapid solidification flakes undergo hydrogen crushing and jet milling to produce R—Ti-M-B—Fe alloy powder. The hydrogen crushing step is carried out at a hydrogen absorption pressure of 0.3 MPa, followed by dehydrogenation at 550° C. The jet milling is conducted at a grinding pressure of 0.55 MPa, yielding R—Ti-M-B—Fe alloy powder with an average particle size (D50) of 3.8 μm.

Preparing the Ti-containing NdFeB magnet by using the R—Ti-M-B—Fe powder: following the molding, sintering, and aging treatments of the obtained R—Ti-M-B—Fe alloy powder, the material is mechanically machined into a Ti-containing NdFeB magnet, designated as CT-5, with dimensions of 15 mm in thickness (orientation direction), 20 mm in length, and 40 mm in width. The molding treatment is oriented molding under N₂ gas protection with an oriented magnetic induction strength of 2 T. The sintering treatment includes the first sintering treatment at 550° C. for 8 h and the second sintering treatment at 1050° C. for 6 h followed by air quenching to room temperature. The aging treatment consists of the first aging treatment at 850° C. for 3.5 h and the second aging treatment at 460° C. for 1 h.

### Comparative Embodiment 1

Referring to the preparation method in Embodiment 1, the difference in Comparative Embodiment 1 lies in sintering treatment, no segmented sintering treatment is adopted. The sintering temperature is 1060° C., and the holding time is 6 hours, resulting in a Ti-doped NdFeB magnet, designated as DCT-1.

### Comparative Embodiment 2

Referring to the preparation method in Embodiment 1, the difference in Comparative Embodiment 2 lies in the first sintering, where the temperature of the first sintering treatment is set at 870° C. with a holding time of 4 h, resulting in a Ti-containing NdFeB magnet, designated as DCT-2.

### Comparative Embodiment 3

Referring to the preparation method in Embodiment 1, the difference in Comparative Embodiment 3 lies in the first sintering, where the temperature of the first sintering treatment is set at 465° C. with a holding time of 8 h, resulting in a Ti-containing NdFeB magnet, designated as DCT-3.

### Test

Embodiments 1-4 and Comparative Embodiments 1-3 of the compositions and contents of the R₁—Fe—B-M₁ primary alloy powder, R₂—Ti-M₂ secondary alloy powder, R—Ti-M-B—Fe alloy powder, and the Ti-containing magnets prepared therefrom, as well as Example 5 of the composition and content of the R—Ti-M-B—Fe alloy powder and the corresponding Ti-containing magnet, were analyzed using an inductively coupled plasma (ICP) elemental analyzer. The results are presented in Tables 1 and 2.

The average particle sizes of the primary alloy powder and the secondary alloy powder are obtained by testing with a particle size analyzer.

The magnet from Embodiment 1 was mirror-polished, and a cross-sectional image was captured using a scanning electron microscope (SEM). The resulting SEM image is shown in FIG. 1.

Position A9 in FIG. 1 was selected for observation using a transmission electron microscope (TEM). The result, depicted in FIG. 2, shows a TiB₂ crystal with a length of 409 nm and a width of 20 nm.

The distribution of TiB₂ crystals within the magnet was analyzed using commercial image analysis software (Image Pro Plus). Multiple arbitrary cross-sections of the magnet (at least 5) were randomly selected for analysis. For each cross-section, multiple regions of 30 μm×20 μm (at least 3) were randomly chosen. For each region, the number of TiB₂ crystals in main phase grains (N₁), the number of TiB₂ crystals in triangular region grain boundary phases (N₂), and the number of TiB₂ crystals in the thin-layer grain boundary phases were counted. The sum of N₁, N₂, and the number of TiB₂ crystals in the thin-layer grain boundary phases is denoted as N. The ratios N₁/N and N₂/N were calculated for each region and averaged to obtain the N₁/N and N₂/N values for the cross-section. These values were then averaged across all cross-sections to determine the N₁/N and N₂/N values within the magnet, as shown in Table 3. In cases where TiB₂ crystals overlapped in the thin-layer grain boundary phases, overlapping crystals were counted as one (e.g., the number of TiB₂ crystals at position A8 in FIG. 1 is counted as 1).

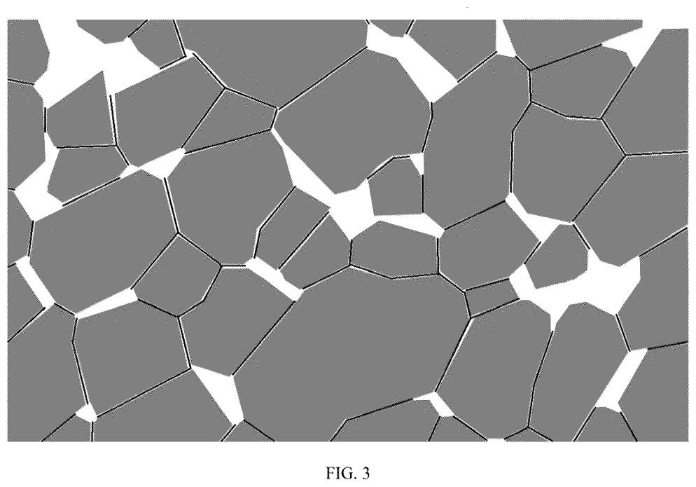

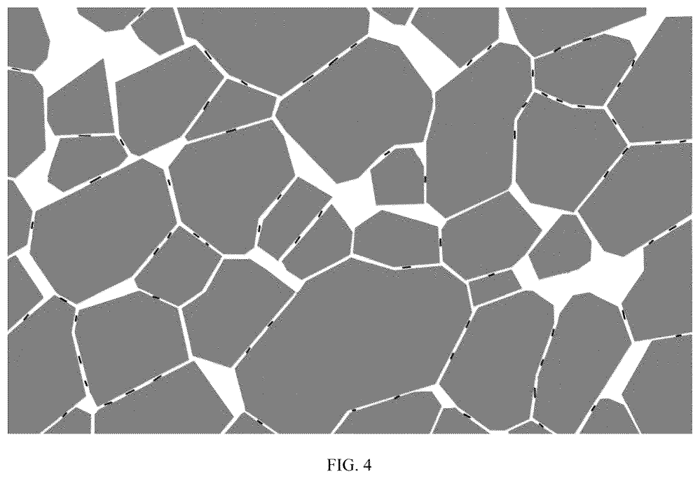

The distribution of TiB₂ crystals in the thin-layer grain boundary phases of the magnet was analyzed as follows: multiple arbitrary cross-sections (at least 5) were randomly selected for analysis. For each cross-section, multiple regions of 30 μm×20 μm (at least 3) were chosen. For each region, the total length L of the thin-layer grain boundary phase (represented by the total length of the black line in FIG. 3) and the total length L_{T} of TiB₂ crystals in the thin-layer grain boundary phase (represented by the total length of the black line in FIG. 4) were measured using image analysis software (Image Pro Plus). The L_{T}/L ratio was calculated for each region and averaged to obtain the L_{T}/L value for the cross-section. These values were then averaged across all cross-sections to determine the L_{T}/L value within the magnet, as listed in Table 3.

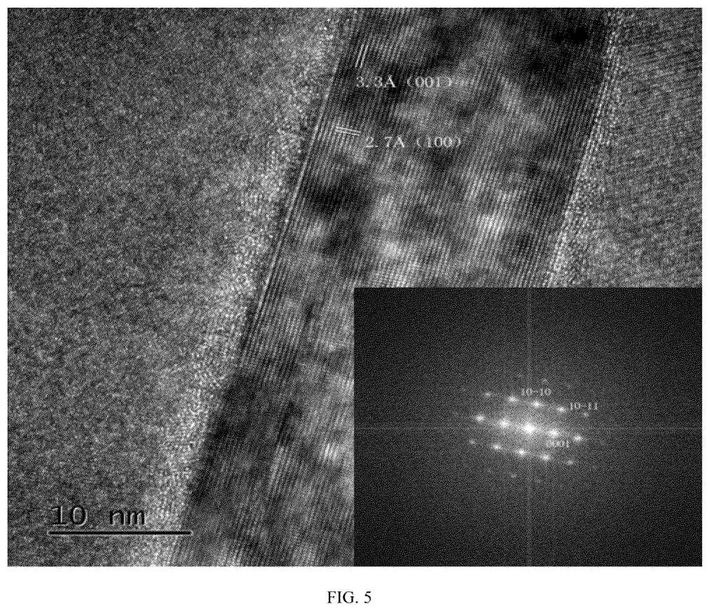

The TiB₂ crystals in the magnet of Embodiment 1 were subjected to electron diffraction testing, and the results are shown in FIG. 5. The analysis of the crystal structure confirmed that the needle-like TiB₂ crystals belong to the hexagonal crystal system.

The magnetic properties of the Ti-containing NdFeB magnets in Embodiments 1-5 and Comparative Embodiments 1-3 were tested using a B-H curve tracer, and the results are listed in Table 3.

TABLE 1
Composition and average particle size of primary alloy powders and secondary alloy powders

| | | | | | | Comparative | Comparative |
|---|---|---|---|---|---|---|---|
| | | Embodiment | Embodiment | Embodiment | Embodiment | Embodiment | Embodiment |
| | composition | 1 | 2 | 3 | 4 | 1 | 2 |
| R₁—Fe—B—M₁ | PrNd | 30.5 | 30.5 | 29.5 | 29.5 | 30.5 | 30.5 |
| primary alloy | Ga | 0.15 | 0.15 | 0.21 | 0.21 | 0.15 | 0.15 |
| powder | Cu | 0.25 | 0.25 | — | — | 0.25 | 0.25 |
| | Co | 0.91 | 0.91 | 1.33 | 1.33 | 0.91 | 0.91 |
| | Al | 0.25 | 0.25 | 0.26 | 0.26 | 0.25 | 0.25 |
| | B | 0.91 | 0.91 | 0.96 | 0.96 | 0.91 | 0.91 |
| | Fe | bal | bal | bal | bal | bal | bal |
| | D50/μm | 3.8 | 3.8 | 3.4 | 3.3 | 3.8 | 3.8 |
| R₂—Ti | PrNd | 85 | 85 | 82 | 57 | 85 | 85 |
| secondary | Cu | — | — | 8 | 8 | — | — |
| alloy powder | Ti | 15 | 15 | 10 | 35 | 15 | 15 |
| | D50/μm | 1.0 | 1.1 | 1.3 | 1.3 | 1.0 | 1.0 |
| Mass ratio | Primary alloy | 99:1 | 99:1 | 39:1 | 39:1 | 99:1 | 99:1 |
| | powder:secondary | | | | | | |
| | alloy powder | | | | | | |

| | | Comparative | | | |
|---|---|---|---|---|---|
| | | Embodiment | | | Embodiment |
| | composition | 3 | | composition | 5 |
| R₁—Fe—B—M₁ | PrNd | 30.5 | R—Ti—M—B—Fe | PrNd | 30.5 |
| primary alloy | Ga | 0.15 | alloy powder | Ga | 0.20 |
| powder | Cu | 0.25 | | Cu | 0.20 |
| | Co | 0.91 | | Co | 0.80 |
| | Al | 0.25 | | A1 | 0.25 |
| | B | 0.91 | | Ti | 0.10 |
| | Fe | bal | | B | 0.90 |
| | D50/μm | 3.8 | | Fe | bal |
| R₂—Ti | PrNd | 85 | | D50/μm | 3.8 |
| secondary | Cu | — | | | |
| alloy powder | Ti | 15 | | | |
| | D50/μm | 0.9 | | | |
| Mass ratio | Primary alloy | 99:1 | | | |
| | powder:secondary | | | | |
| | alloy powder | | | | |

TABLE 2
Composition of Ti-containing NdFeB magnets

| Sample number | PrNd/wt % | Ga/wt % | Cu/wt % | Co/wt % | Al/wt % | Ti/wt % | B/wt % | Fe/wt % |
|---|---|---|---|---|---|---|---|---|
| Embodiment 1 | 31 | 0.15 | 0.25 | 0.9 | 0.25 | 0.15 | 0.9 | bal |
| Embodiment 2 | 31 | 0.15 | 0.25 | 0.9 | 0.25 | 0.15 | 0.9 | bal |
| Embodiment 3 | 30.8 | 0.2 | 0.2 | 1.3 | 0.25 | 0.25 | 0.94 | bal |
| Embodiment 4 | 30.19 | 0.20 | 0.20 | 1.30 | 0.25 | 0.88 | 0.94 | bal |
| Embodiment 5 | 30.15 | 0.20 | 0.20 | 0.80 | 0.25 | 0.10 | 0.9 | bal |
| Comparative | 31 | 0.15 | 0.25 | 0.9 | 0.25 | 0.15 | 0.9 | bal |
| Embodiment 1 | | | | | | | | |
| Comparative | 31 | 0.15 | 0.25 | 0.9 | 0.25 | 0.15 | 0.9 | bal |
| Embodiment 2 | | | | | | | | |
| Comparative | 31 | 0.15 | 0.25 | 0.9 | 0.25 | 0.15 | 0.9 | bal |
| Embodiment 3 | | | | | | | | |

TABLE 3
Performance Data of Ti-containing NdFeB magnets.

| | Br/KGs | HCJ/KOe | Squareness | L_{T}/L | N₁/N | N₂/N |
|---|---|---|---|---|---|---|
| CT-1 | 13.11 | 19.12 | 0.97 | 0.45 | 0.02 | 0.09 |
| CT-2 | 13.04 | 18.61 | 0.93 | 0.35 | 0.02 | 0.3 |
| CT-3 | 13.43 | 19.72 | 0.96 | 0.53 | 0.01 | 0.08 |
| CT-4 | 12.98 | 18.52 | 0.93 | 0.38 | 0.01 | 0.28 |
| CT-5 | 13.21 | 18.82 | 0.96 | 0.41 | 0.05 | 0.1 |
| DCT-1 | 12.76 | 18.32 | 0.92 | 0.11 | 0.06 | 0.72 |
| DCT-2 | 12.77 | 18.38 | 0.92 | 0.13 | 0.05 | 0.7 |

As shown in Table 3, the present disclosure employs a segmented sintering process at different temperatures to sinter the green compact. The green compact is held at a temperature between 480° C. and 850° C. for 5 to 10 hours in the first sintering process, allowing Ti elements to distribute more extensively in the thin-layer grain boundary phase. Subsequently, in the second sintering step (the second sintering temperature is in a range of 900° C. to 1080° C.), Ti elements combine with B elements, leading to the in-situ formation of fine, uniformly distributed nanoscale needle-like TiB₂ crystals within the thin-layer grain boundary phase of the magnet. This process also effectively reduces the number of TiB₂ crystals within the main-phase grains and in the triangular region grain boundaries. The needle-like TiB₂ crystals, abundantly present in the thin-layer grain boundary phase of the magnet, persist in the thin-layer grain boundary phase between adjacent main-phase grains, effectively separating the main-phase grains. The TiB₂ crystals exert a “pinning” effect on the grain boundary movement of the main-phase grains, thereby effectively inhibiting the growth of the main-phase grains. The present disclosure achieves significant improvements in the coercivity and squareness of the Ti-containing NdFeB magnets, with excellent magnetic properties, even with reduced usage or complete absence of heavy rare earths.

Comparing Embodiment 2 with Embodiment 1, it can be observed that controlling the temperature of the first sintering process within the range of 500° C. to 850° C. enables a greater distribution of Ti elements in the thin-layer grain boundary phase. Subsequent controlling the temperature of the sintering process within the range of 900° C. to 1080° C. further promotes the combination of Ti and B elements, resulting in a further reduction of TiB₂ crystal quantity within the main-phase grains and the triangular region grain boundary phase. This process also increases the quantity of fine, uniformly distributed needle-like TiB₂ crystals formed in-situ within the thin-layer grain boundary phase, thereby further enhancing the coercivity and squareness of the prepared magnet.

When comparing the Embodiment 4 with the Embodiment 1, it becomes apparent that by meticulously controlling the Ti element content in the secondary alloy within the range specified in this application, the Ti element concentration in the magnet can be precisely regulated. This optimization enables more effective combination of the Ti element with the B element, further augmenting the coercivity and squareness of the produced magnetic material.

A comparison of the Embodiment 5 and the Embodiment 1 reveals that the utilization of a dual-alloy process for the preparation of Ti-containing NdFeB magnets results in an increased quantity of finely dispersed, needle-like TiB₂ crystals within the grain boundary phase of the thin-layer grain boundary phase. Concurrently, this approach further diminishes the presence of TiB₂ crystals within the main phase grains. The TiB₂ crystal particles in the thin-layer grain boundary phase thus serve as effective magnetic isolators, preventing main phase grain growth and consequently enhancing the coercivity and squareness of the magnets.

A comparison of the Comparative Embodiment 1 with the Embodiment 1 demonstrates that, the absence of segmented sintering, with direct sintering of mixed alloy raw materials at a high temperature of 1060° C., hinders the full diffusion of the Ti element into the thin-layer grain boundary phase. This leads to the majority of TiB₂ crystals being localized within the main phase grain interiors and triangular region grain boundary phases, with limited in-situ generation and uneven distribution of TiB₂ crystals in the thin-layer grain boundaries. Consequently, these crystals are unable to adequately function as magnetic isolators between adjacent main phase grains, resulting in insufficient grain separation, enlarged main phase grain size, and significant reductions in residual magnetization, coercivity, and squareness of the magnet.

Furthermore, a comparison of the Comparative Embodiment 2 and the Comparative Embodiment 3 with the Embodiment 1 underscores the importance of adhering to the specified temperature range for the first sintering treatment. Deviation from this temperature range of the first sintering treatment impedes the sufficient diffusion of the Ti element into the thin-layer grain boundary phase. Subsequently, during the second sintering treatment, effective combination of the Ti element with the B element is compromised, leading to sparse and unevenly distributed needle-like TiB₂ crystals within the grain boundary phase. This impairment in crystal distribution and function as magnetic isolator results in poor separation of main phase grains, increased the main grain size, and substantial decreases in residual magnetism, coercivity, and squareness of the magnet.

Some embodiments of the present disclosure have been described in detail above in conjunction with the accompanying drawings. However, the present disclosure is not limited to the specific details of the above embodiments, and within the technical scope of the present disclosure, various simple modifications can be made to the technical solutions of the present disclosure, all of which fall within the scope of protection of the present disclosure.

The specific technical features described in the above-mentioned specific implementation methods can be combined in any appropriate way, as long as they are not contradictory. In order to avoid unnecessary repetitions, this disclosure does not separately explain all possible combinations.

In addition, various different embodiments of the present disclosure can also be combined in any way, as long as they do not depart from the spirit of the present disclosure, they should also be considered as the content disclosed by the present disclosure.

1. A Ti-containing NdFeB magnet comprising main phase grains, thin-layer grain boundary phases, and triangular region grain boundary phases, and comprising TiB₂ crystals;
wherein a distribution of TiB₂ crystals in the Ti-containing NdFeB magnet satisfies:
$$0 \leq {N}_{1} / N \leq 0.05 ; and \\ 0 \leq {N}_{2} / N \underline{<} 0.3 ;$$
where:
N₁ represents a number of TiB₂ crystals distributed within the main phase grains,
N₂ represents a number of TiB₂ crystals in the triangular region grain boundary phases, and
N represents a total number of TiB₂ crystals distributed in the main phase grains, the triangular region grain boundary phases, and the thin-layer grain boundary phases.

2. The Ti-containing NdFeB magnet according to claim 1, wherein 0≤N₂/N≤0.2.

3. The Ti-containing NdFeB magnet according to claim 1, wherein a length of the TiB₂ crystal is in a range of 100 nm to 500 nm, and a width of the TiB₂ crystal is in a range of 1 nm to 20 nm.

4. The Ti-containing NdFeB magnet according to claim 1, wherein, a distribution of TiB₂ crystals within the thin-layer grain boundary phases satisfies.
$$0.3 \leq {L}_{T} / L \leq 0.8 ;$$
where L_{T} represents a total length L_{T} of the TiB₂ crystals within the thin-layer grain boundary phases, and L represents a total length of the thin-layer grain boundary phases.

5. The Ti-containing NdFeB magnet according to claim 1, wherein:
the Ti-containing NdFeB magnet includes R, Ti, M, B, and Fe;
the R element includes at least one of Nd, Pr, Dy, Tb, Ho, La, Y, or Ce, and the M element includes at least one of Cr, Co, Ni, Ga, Cu, Al, Zr, Nb, Mo, Sn, Hf, or W; and
a mass percentage of R element is in a range of 28.5% to 31.5%, a mass percentage of Ti element is in a range of 0.05% to 0.75%, a mass percentage of M element is in a range of 1.2% to 2.5%, a mass percentage of B element is in a range of 0.9% to 0.97%, and the remainder is Fe.

6. A method of producing the Ti-containing NdFeB magnet according to claim 1 comprising:
performing molding process on R—Ti-M-B—Fe alloy powder to obtain a green compact;
performing sintering process on the green compact to obtain a sintered compact; and
performing aging treatment on the sintered compact to obtain the magnet;
wherein:
the sintering process includes first sintering and second sintering; and
the first sintering is performed at a first sintering temperature in a range of 480° C. to 850° C. for a first sintering time in a range of 5 h to 12 h, and the second sintering is performed at a second sintering temperature in a range of 900° C. to 1100° C. for a second sintering time in a range of 1 h to 10 h.

7. The method according to claim 6, wherein the first sintering temperature is in a range of 500° C. to 850° C., the first sintering time is in a range of 5 h to 10 h, the second sintering temperature is in a range of 900° C. to 1080° C., and the second sintering time is in a range of 1 h to 6 h.

8. The method according to claim 6, wherein in the R—Ti-M-B—Fe alloy powder:
R includes at least one of Nd, Pr, Dy, Tb, Ho, La, Y, or Ce, and M includes at least one of Cr, Co, Ni, Ga, Cu, Al, Zr, Nb, Mo, Sn, Hf, or W; and
a mass percentage of R element is in a range of 28.5% to 31.5 wt %, a mass percentage of Ti element is in a range of 0.05% to 0.75%, a mass percentage of M element is in a range of 1.2% to 2.5%, a mass percentage of B element is in a range of 0.9% to 0.97%, and the remainder is Fe.

9. The method according to claim 6, further comprising:
preparing R—Ti-M-B—Fe alloy flakes using rapid solidification process;
subjecting the R—Ti-M-B—Fe alloy flakes to hydrogen decrepitation and jet milling to obtain the R—Ti-M-B—Fe alloy powder;
wherein an average particle size D50 of the R—Ti-M-B—Fe alloy powder is in a range of 2 μm to 5 μm.

10. The method according to claim 6, further comprising:
mixing R₁—Fe—B-M₁ primary alloy powder and R₂—Ti-M₂ secondary alloy powder to obtain the R—Ti-M-B—Fe alloy powder;
wherein:
a mass ratio of the R₁—Fe—B-M₁ primary alloy powder to the R₂—Ti-M₂ secondary alloy powder is 10:1 to 150:1;
in the R₁—Fe—B-M₁ primary alloy powder:
R₁ includes at least one of Nd, Pr, Dy, Tb, Ho, La, Y, or Ce, and M₁ includes at least one of Cr, Co, Ni, Ga, Cu, Al, Zr, Nb, Mo, Sn, Hf, or W; and
a mass percentage of R₁ element is in a range of 28% to 31%, a mass percentage of M₁ element is in a range of 0.5% to 3%, a mass percentage of B element is in a range of 0.85% to 0.97%, and the remainder is Fe; and
in the R₂—Ti-M₂ secondary alloy powder:
R₂ includes at least one of Pr or Nd, and M₂ includes at least one of Co, Cu, Al, or Ga; and
A mass percentage of R element is in a range of 50% to 95%, a mass percentage of Ti element is in a range of 5% to 30%, and a mass percentage of M₂ element is lower than 20%.

11. The method according to claim 6, further comprising:
preparing R₁—Fe—B-M₁ primary alloy flakes using rapid solidification process, and subjecting the R₁—Fe—B-M₁ primary alloy flakes to hydrogen decrepitation and jet milling to obtain the R₁—Fe—B-M₁ primary alloy powder, an average particle size D50 of the R₁—Fe—B-M₁ primary alloy powder being in a range of 2 μm to 5 μm; and
preparing R₂—Ti-M₂ secondary alloy flakes using rapid solidification process, and subjecting the R₂—Ti-M₂ secondary alloy flakes to hydrogen decrepitation and jet milling to obtain the R₂—Ti-M₂ secondary alloy powder, an average particle size D50 of the R₂—Ti-M₂ secondary alloy powder being in a range of 0.5 μm to 2 μm.

12. The method according to claim 6, wherein:
the molding process is an orientation molding process with an orientation magnetic induction intensity in a range of 1.8 T to 2.5 T; and
the aging treatment includes:
a first aging process at a first aging temperature in a range of 850° C. to 950° C. for a first aging time in a range of 3 h to 5 h; and
a second aging process at a second aging temperature in a range of 450° C. to 600° C. for a second aging time in a range of 0.5 h to 5 h.
